(19) United States
(12) Patent Application Publication
(10) Pub. No.: US 2006/0282232 A1
(43) Pub. Date: Dec. 14, 2006

(54) Method of inspecting 3D scanned data using parametric tolerance

(75) Inventors: Seock Hoon Bae, Gyeonggi (KR); Dong Hoon Lee, Seoul (KR)

Correspondence Address: HARNESS, DICKEY & PIERCE, P.L.C., P.O. BOX 828, BLOOMFIELD HILLS, MI, 48303, US

(73) Assignee: INUS TECHNOLOGY, INC.

(21) Appl. No.: 11/284,148

(22) Filed: Nov. 21, 2005

(30) Foreign Application Priority Data
Jun. 10, 2005 (KR) 10-2005-0049785

(51) Int. Cl. G01C 17/00

(52) U.S. Cl. 702/152

(57) ABSTRACT

There is provided a method of inspecting 3D scanned data using parametric tolerances, with the method including setting the number of parametric tolerance objects to be equal to that of allowable tolerances in the design data of an inspection object, connecting the design data of the inspection object with the predetermined parametric tolerance object without directly inputting the allowable tolerance of each field into the design data of the inspection object, and automatically changing the allowable tolerance value of the field connected to the design data when the parametric tolerance value is changed. Consequently, each tolerance value corresponding to a design data field does not need to be edited all over again when a range of the allowable tolerance is changed according to the design modification. The allowable tolerance used in the design data is classified and set as the parametric tolerance and the design data is connected with the predetermined parametric tolerance classified according to the allowable tolerance. Then, measurement data of the inspection object measured through a scanner and the design data are compared and inspected. Subsequently, a report is generated or the parametric tolerance is modified and recalculated according to the parametric tolerance. Accordingly, an allowable tolerance value can be automatically modified without modifying the allowable tolerance value of the design data all over again when an allowable tolerance zone of the design data is changed.

### BACKGROUND OF THE INVENTION

1. Field of the Invention

The present invention relates to the inspection of 3D scanned data using parametric tolerances, and in particular, to a method of inspecting 3D scanned data using parametric tolerances, in which the method includes the steps of setting the number of parametric tolerance objects to be equal to that of allowable tolerances on the design data of an inspection object, connecting the design data of the inspection object with the predetermined parametric tolerance object without directly inputting a numerical value for the allowable tolerance of each field, and automatically changing the allowable tolerance value of the field connected to the design data by changing only the parametric tolerance value when the parametric tolerance value is changed. Consequently, each tolerance value that corresponds to a design data field does not need to be edited all over again when a range of the allowable tolerance is changed due to design modification.

2. Description of the Related Art

Generally, measurement systems using 3D scanners include contact methods that directly contact a measurement object, and non-contact methods that obtain structural information about an object by digitizing a structure captured using imaging equipment.

Measurement systems employing 3D scanners are used to acquire structural information of measurement objects that are fragile when subjected to external pressures such as the manufacturing of semiconductor wafers, the measuring of precision machinery, and the reconstruction of 3D images or high precision miniature components. Structural information acquired through a 3D scanner is examined and compared with predetermined design data.

A conventional industrial product is usually expressed with a model that combines the structural characteristics of the product. However, with the development of modeling technology and consumers' needs, products with aesthetic curved surfaces have been developed recently.

Accordingly, technology for efficiently dealing with products having curved surfaces and lines is required, and techniques for modeling these products have traditionally been studied in the graphics field. Now, the technique is becoming more and more applicable to the product development field.

Most product design data have various tolerances according to each component. Because much processing time and expense is consumed when allowable tolerances are low, a designer may indicate a plurality of tolerances for a characteristic factor of a product on a drawing according to the importance of the characteristic factor.

A single allowable tolerance is usually assigned to an entire design data to perform various tests, and a plurality of the allowable tolerance can be assigned to a specific area of design data to perform various tests in technology for inspecting the differences between design data and the 3D scanned data for a prototype. However, there are complications in the work process because the method involves directly inputting each allowable tolerance after selecting a corresponding measurement component of the design data.

Additionally, there is the problem that a process for modifying the design data of an inspection object needs to be repeated all over again when a product designer changes the allowable tolerance in the method described above.

Accordingly, a method of inspecting 3D data using a parametric tolerance is proposed to solve the problem of requiring a user to edit the design data of an inspection object all over again when the allowable tolerance of a product is changed and allow systematical maintenance of allowable tolerances.

### SUMMARY OF THE INVENTION

Accordingly, the present invention is directed to a method of inspecting 3D scanned data using parametric tolerances that substantially obviates one or more problems due to the limitations and disadvantages of the related art.

The objective of the present invention is to provide a method of inspecting 3D scanned data using parametric tolerances, with the method including the steps of: setting the number of parametric tolerance objects to be equal to that of allowable tolerances in design data of an inspection object; connecting the design data of the inspection object with the predetermined parametric tolerance object without directly inputting a numerical value for the allowable tolerance of each field; and automatically changing the allowable tolerance value of the field connected to the design data by changing only the parametric tolerance value when the parametric tolerance value is changed. Consequently, each tolerance value corresponding to a design data field does not need to be edited all over again when a range of the allowable tolerance is changed according to the design modification.

To accomplish the above objective and other advantages, there is provided a method for inspecting 3D scanned data using parametric tolerances, with the method including the steps of detecting the design data of an inspection object and setting parametric tolerance by classifying allowable tolerances in the detected design data with a control unit; assigning the parametric tolerances set in the step (a) to the design data with the control unit; performing a comparison test of the design data to the measurement data of the inspection object measured through a scanner with the control unit; and generating a report displaying the test results of the measurement data or modifying the parametric tolerance with the control unit according to the comparison test result.

Additionally, the parametric tolerance is assigned to at least one of the following a curved line of the design data, a curved surface of the design data, and Geometric Dimensioning & Tolerancing (GD&T) in the assigning of the parametric tolerance classified according to the allowable tolerance to the design data at the control unit.

Additionally, the report displays the comparison test result as numerical information as well as image information in the generation of the report for displaying a test result of the measurement data or modifying the parametric tolerance at the control unit according to the comparison test result.

Moreover, the parametric tolerance modification modifies the parametric tolerance set when setting the parametric tolerance by classifying the allowable tolerance in the detected design data at a control unit, and recalculating the comparison test according to the modified parametric tolerance in the generation of the report for displaying a test result of the measurement data or modifying the parametric tolerance at the control unit according to the comparison test result.

It is to be understood that both the foregoing general description and the following detailed description of the present invention are exemplary and explanatory and are intended to provide further explanation of the present invention as claimed.

### BRIEF DESCRIPTION OF THE DRAWINGS

The accompanying drawings, which are included to provide a further understanding of the present invention and are incorporated in and constitute a part of this application, illustrate embodiment (s) of the present invention and together with the description serve to explain the principle of the present invention. In the drawings:

FIG. 1 is a block diagram illustrating components of a system for inspecting data using parametric tolerances according to an embodiment of the present invention.

FIG. 2 is a flow chart illustrating a method of inspecting 3D scanned data using parametric tolerances according to an embodiment of the present invention.

FIG. 3 is an exemplary view illustrating a process of setting a parametric tolerance according to the inspecting method of FIG. 2.

FIG. 4 is an exemplary view illustrating a process of assigning an assigned parametric tolerance in FIG. 3 to design data.

### DETAILED DESCRIPTION OF THE PREFERRED EMBODIMENTS

Reference will now be made in detail to a preferred embodiment of the present invention.

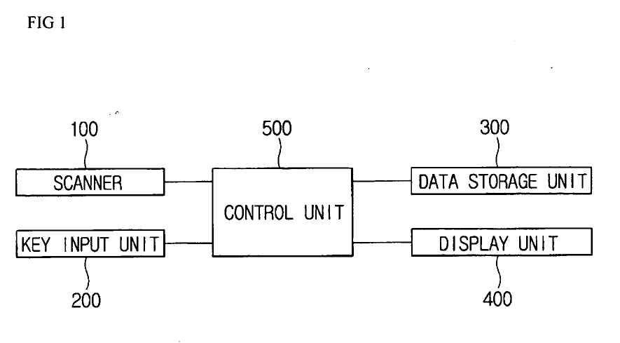

FIG. 1 is a block diagram illustrating components of a system for inspecting data using the parametric tolerance according to an embodiment of the present invention. Referring to FIG. 1, a system for inspecting data using the parametric tolerance includes a 3D scanner (100) for scanning a measurement object, a data storage unit (300) for storing design data and allowable tolerance information of the design data to perform a comparison test with data measured from the measurement object, a display unit (400) for displaying measurement information detected from the 3D scanner and inspection guiding information of the measurement object stored in the data storage unit (300), and a control unit (500) for controlling overall operations of an inspection guiding system. A reference number (200) represents a key input unit for inputting information related to the allowable tolerance of the design data.

Additionally, the design data stored in the data storage unit (300), being design information of the measurement object, is a design data modeled through a CAD program.

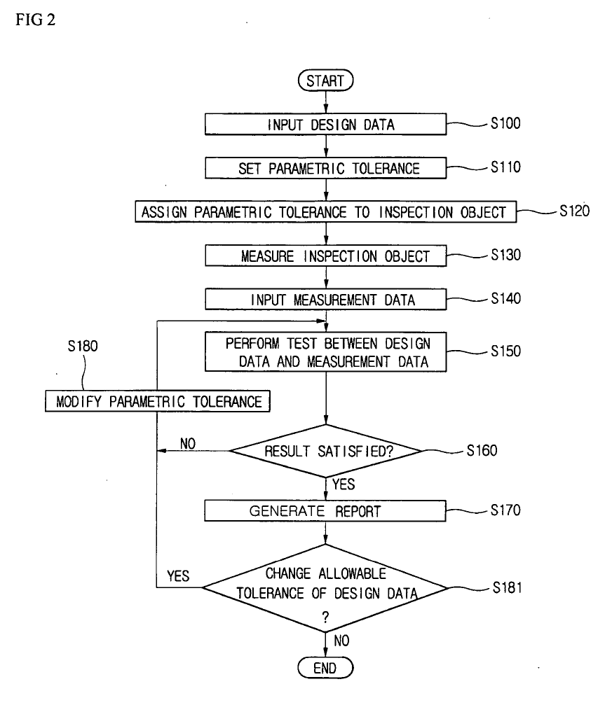

FIG. 2 is a flow chart illustrating a method of inspecting 3D scanned data using parametric tolerances according to an embodiment of the present invention. Referring to FIGS. 1 and 2, a method of inspecting data using parametric tolerance will now be described in more detail.

The control unit (500) detects design data of an inspection object previously stored in the data storage unit (300) or is inputted with the design data of the inspection object through an external input unit (not shown) in step S100. After that, the controller (500) sets the number of parametric tolerances to be equal to that of allowable tolerances by detecting the allowable tolerance within the inputted design data in step S110. That is, the allowable tolerance of a measurement component classified according to the measurement field and importance is detected from the design data of the inspection object, and a parametric tolerance object (hereinafter, referred to as a parametric tolerance) corresponding to the detected allowable tolerance is generated.

After performing step S110, the control unit (500) assigns the allowable tolerance of the defined design data to be connected with the parametric tolerance in step S120. Additionally, the allowable tolerance is classified according to the measurement field and importance in the design data. That is, the control unit (500) assigns the allowable tolerances of a curved line, a curved surface, Geometric Dimensioning & Tolerancing (GD&T), etc. to the design data in step S120. Also, a curved surface group is connected with the data of the allowable tolerance. When connecting an allowable tolerance in the design data of an inspection object with the predetermined parametric tolerance, the allowable tolerance is not changed by directly inputting numbers one by one when an allowable tolerance value or a range of the allowable tolerance is changed according to a design modification of the design data. The method of the present invention automatically changes an allowable tolerance value of the design data field by just modifying the parametric tolerance connected with the allowable tolerance of a corresponding design data field.

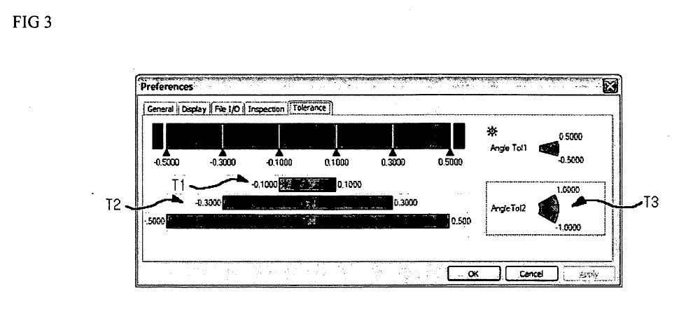

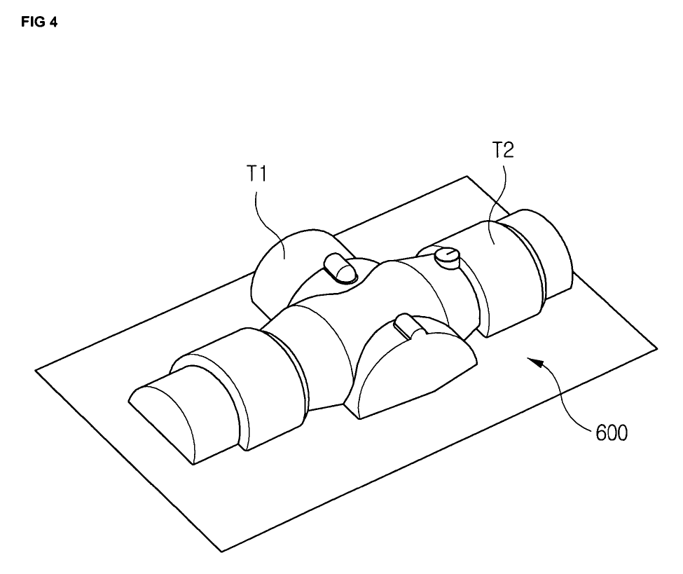

FIG. 3 is an exemplary view illustrating a process of setting a parametric tolerance according to the inspecting method of FIG. 2, FIG. 4 is an exemplary view illustrating a process of assigning an assigned parametric tolerance in FIG. 3 to a design data.

Parametric tolerances of inspection object components T 1, T 2, and T 3 are defined on a surface of design data 600 of an inspection object. For example, T1 is a parametric tolerance defining an allowable tolerance for the length or size of a curved surface of a designed component in the design data (600) of the inspection object. A parametric tolerance with a range of −0.1˜0.1 is registered.

Also, T2 is a parametric tolerance defining the allowable tolerance for length or size of a curved surface of another designed component in the design data (600) of the inspection object. A parametric tolerance with a range of −0.3˜0.3 is registered.

Additionally, it is possible to define a parametric tolerance for an angle of the component other than length or size of a curved surface of a designed component in the design data 600 of an inspection object. T3 defines allowable tolerance for an angle of an inspection object, and is a parametric tolerance with an allowable tolerance of −1˜1 for an angle of a curved surface.

That is, the connected parametric tolerance in FIG. 3 connects with the design data (600) of the inspection object in FIG. 4 and automatically sets an allowable tolerance field of the design data. Since parametric tolerance of T1 is −0.1˜0.1, the same effect as providing design data with a decrease of −0.1 or an increase of 0.1 is provided.

Referring to FIGS. 1 and 2, after performing step S120, the control unit (500) receives an input of measurement data in the inspection object in step S140, which is measured from the inspection object S130 through the scanner (100) and performs a comparison test in step S150 with the design data and the inputted measurement data. The measurement data position and the design data position needs to be identical and a point group identical to an inspection object component of the design data is detected from a point group of the measurement data.

Additionally, in step S150, whether the measured component data, for example, parametric tolerance T1 and T2 in FIGS. 3 and 4, satisfies requirements or not is decided in step S160 by comparing the measurement data identical to the inspection object of the design data with the parametric tolerance assigned to the design data. In step S160, if the measured data satisfies requirements of the parametric tolerances, the control unit (500) generates a report in step S170 about text information, numerical information, and image information for a test result of measurement data and design data, and displays the written report through a display unit.

After performing step S170, the control unit (500) decides whether an allowable tolerance of design data changes or not by a control signal inputted from a key input part (200) and saves the report in the data storage unit (300), and terminates a program if it detects a signal for maintaining the allowable tolerance of the design data, for example, a signal for saving the written report in the data storage unit (300).

However, if a control signal for changing the allowable tolerance of the design data from the key input unit (200) is detected in step S181, the controller (500) generates a report for a test result of the measurement data by detecting a revised value for modifying the allowable tolerance of the design data from the key input unit (200) in step S180, modifying the parametric tolerance predetermined in step S110, and automatically recalculating a comparison test between measurement data and the design data according to the modified parametric tolerance.

On the other hand, if the measured data does not meet the requirement of the parametric tolerance in step S160, or an allowable tolerance value of the design data or a range of the allowable tolerance is changed, the control unit (500) does not modify the allowable tolerance all over again by selecting each curved surface of the design data, but generates a report for a test result by modifying the parametric tolerance in step S180 predetermined in step S110 and automatically recalculates a comparison test between the measurement data and design data.

Additionally, it is possible to display separate colors to differentiate between the design data and the measurement data according to a variation of the parametric tolerance.

As described above, a method of inspecting 3D data using parametric tolerances according to the present invention has the advantage of easily modifying allowable tolerance values by automatically changing a connected allowable tolerance value correspondingly to the change of a parametric tolerance value if a user wants to change an allowable tolerance zone of design data without changing tolerance values respectively all over again by selecting design data of all curved surfaces.

Additionally, the present invention has another advantage of verifying a tolerance simulation of a change in a curved line of design data, a curved surface of design data, and a GD&T inspection value by automatically recalculating using a change of an allowable tolerance data value.

The foregoing embodiment is merely exemplary and is not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method for inspecting 3D scanned data using parametric tolerances, with the method comprising the steps of:
(a) detecting design data of an inspection object and setting parametric tolerances by classifying allowable tolerance in the detected design data at a control unit;
(b) assigning the parametric tolerance set in step (a) to the design data at the control unit;
(c) performing a comparison test of the design data to measurement data of the inspection object measured through a scanner at the control unit; and
(d) generating a report for displaying a test result of the measurement data or modifying the parametric tolerance at the control unit according to the comparison test result.

2. The method of claim 1, wherein the parametric tolerance of the step (b) assigns at least one among a curved line of the design data, a curved surface of the design data, and GD&T (Geometric Dimensioning & Tolerancing).

3. The method of claim 1, wherein the report of the step (d) displays the comparison test result as numerical information and image information.

4. The method of claim 1, wherein the parametric tolerance modification of step (d) modifies the parametric tolerance set in step (a), and recalculates the comparison test according to the modified parametric tolerances.
